(19) United States
(12) Patent Application Publication
(10) Pub. No.: US 2024/0388319 A1
(43) Pub. Date: Nov. 21, 2024

(54) SHARED LOCAL OSCILLATORS IN PHASED ARRAY ANTENNAS

(71) Applicant: Space Exploration Technologies Corp., Hawthorne, CA (US)

(72) Inventors: Masoud Kahrizi, Irvine, CA (US); Ali Sajjadi, Irvine, CA (US); Edward Yeuan, Irvine, CA (US); Alex Ahmad Mirzaei, Tustin, CA (US); Nooshin Vakilian, Irvine, CA (US); Eric Pepin, Seattle, WA (US)

(21) Appl. No.: 18/665,028

(22) Filed: May 15, 2024

Related U.S. Application Data
(60) Provisional application No. 63/466,941, filed on May 16, 2023.

(51) Int. Cl. H04B 1/403; H01Q 3/36; H04B 7/06; H04B 7/08

(52) U.S. Cl. CPC H04B 1/403; H01Q 3/36; H04B 7/0617; H04B 7/086

(57) ABSTRACT

Systems and techniques for distributing reference signals are disclosed. For example, a method includes generating, by a first phase-locked loop (PLL) included in a first beamformer (BF) chip, a first local oscillator (LO) signal; generating, by a second PLL included in a second BF chip, a second LO signal; and in a first BF configuration, transmitting radio frequency (RF) signals by a plurality of antenna elements based on the first LO signal. A first subset of the plurality of the antenna elements is associated with the first BF chip and a second subset of the plurality of antenna elements is associated with the second BF chip. The method includes, in a second BF configuration, receiving RF signals by the first subset of the plurality of antenna elements and the second subset of the plurality of antenna elements based on the second LO signal.

### TECHNICAL FIELD

The present disclosure pertains to antenna apparatuses for satellite communication systems and shared local oscillators in phased array antennas.

### BACKGROUND

An antenna (such as a dipole antenna) typically generates radiation in a pattern that has a preferred direction. For example, the generated radiation pattern is stronger in some directions and weaker in other directions. Likewise, when receiving electromagnetic signals, the antenna has the same preferred direction. Signal quality (e.g., signal to noise ratio or SNR), whether in transmitting or receiving scenarios, can be improved by aligning the preferred direction of the antenna with a direction of the target or source of the signal. However, it is often impractical to physically reorient the antenna with respect to the target or source of the signal. Additionally, the exact location of the source/target may not be known. To overcome some of the above shortcomings of the antenna, a phased array antenna can be formed from a set of antenna elements to simulate a large directional antenna. An advantage of a phased array antenna is its ability to transmit and/or receive signals in a preferred direction (e.g., the antenna's beamforming ability) without physical repositioning or reorientating.

It would be advantageous to configure phased array antennas having increased bandwidth while maintaining a high ratio of the main lobe power to the side lobe power. Likewise, it would be advantageous to configure phased array antennas and associated circuitry having reduced weight, reduced size, lower manufacturing cost, and/or lower power requirements. Accordingly, embodiments of the present disclosure are directed to these and other improvements in phased array antennas or portions thereof.

### SUMMARY

In some examples, systems and techniques are described for sharing local oscillator (LO) signals in a phased array antenna system.

According to at least one example, a method is provided for sharing LO signals in a phased array antenna system. The method includes: a plurality of antenna elements; a reference clock; and a beamformer (BF) chip comprising: output a LO signal by a LO signal output based on the reference clock; and a LO signal input/output (IO) port configured to output the LO signal from the BF chip in a first beamforming configuration and to receive an additional LO signal in a second beamforming configuration.

In another example, an apparatus for sharing a local oscillator is provided that includes at least one memory and at least one processor coupled to the at least one memory. The at least one processor is configured to: a plurality of antenna elements; a reference clock; and a BF chip comprising: output a LO signal by a LO signal output based on the reference clock; and a LO signal IO port configured to output the LO signal from the BF chip in a first beamforming configuration and to receive an additional LO signal in a second beamforming configuration.

In another example, a non-transitory computer-readable medium is provided that has stored thereon instructions that, when executed by one or more processors, cause the one or more processors to: a plurality of antenna elements; a reference clock; and a BF chip comprising: output a LO signal by a LO signal output based on the reference clock; and a LO signal IO port configured to output the LO signal from the BF chip in a first beamforming configuration and to receive an additional LO signal in a second beamforming configuration.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is an example illustration of a block diagram of at least a portion of a communication node in accordance with some examples of the present disclosure;

FIG. 1B is an additional example illustration of a block diagram of at least a portion of a communication node in accordance with some examples of the present disclosure;

FIG. 2 is an example illustration of a top view of an antenna lattice in accordance with some examples of the present disclosure;

FIG. 3 is an example illustration showing circuitry or electrical components included in and/or associated with a digital beam former (DBF) chip in accordance with some examples of the present disclosure;

FIG. 4 is an example illustration showing circuitry or electrical components included in and/or associated with a pair of DBF chips in a shared local oscillator (LO) configuration in accordance with some examples of the present disclosure;

FIG. 5 is an example illustration showing circuitry or electrical components included in and/or associated with three DBF chips in a shared LO configuration in accordance with some examples of the present disclosure;

FIG. 6 is an example illustration showing circuitry or electrical components included in and/or associated with five DBF chips in a shared LO configuration in accordance with some examples of the present disclosure;

FIG. 7 is a flowchart illustrating an example method for operating a phased array antenna system in accordance with some examples of the present disclosure;

FIG. 8 illustrates an example computing device architecture, in accordance with some examples of the present disclosure.

### DETAILED DESCRIPTION

Embodiments of apparatuses and methods relate to digital beamforming transmitters and receivers included in a communications system. Examples of the devices, systems, and/or methods of various embodiments are provided below. An embodiment of the devices, systems, and/or methods can include any one or more, and any combination of, the examples described below.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “top surface”, “bottom surface”, “vertical”, “horizontal”, and “lateral” in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

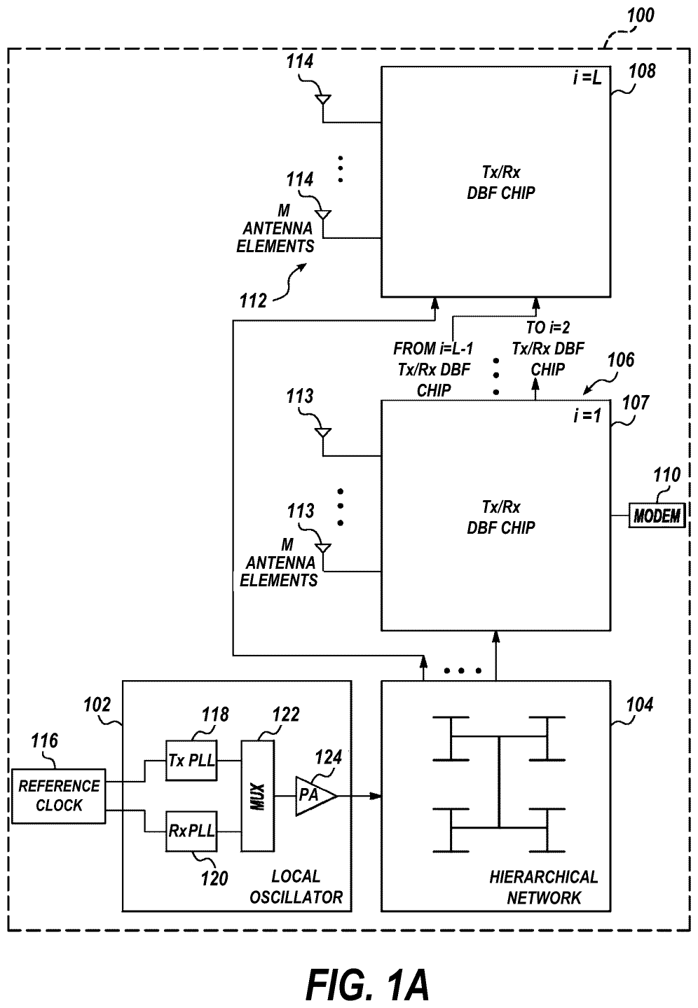

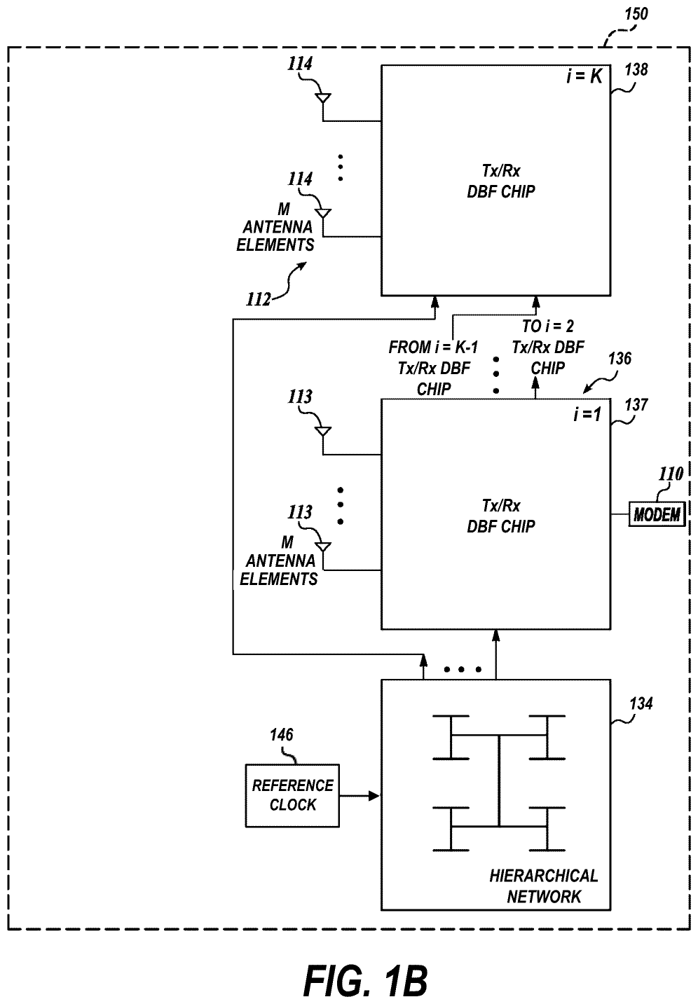

FIG. 1A is an example illustration of a block diagram of at least a portion of a communication node 100 in accordance with some embodiments of the present disclosure. Communication node 100 includes a local oscillator (LO) 102, a hierarchical network 104, a plurality of digital beamformer (DBF) chips 106, a modem 110, a plurality of antenna elements 112, and a reference clock 116. LO 102 is electrically coupled between the reference clock 116 and the hierarchical network 104. Hierarchical network 104 is electrically coupled between LO 102 and each DBF chip of the plurality of DBF chips 106. Modem 110 electrically couples to the first DBF chip of the plurality of DBF chips 106 (e.g., DBF chip 107). Each DBF chip of the plurality of DBF chips 106 electrically couples with a respective subset of the plurality of antenna elements 112.

Each DBF chip of the plurality of DBF chips 106 is similarly configured and associated with a respective subset of the plurality of antenna elements 112. A global LO 102 supports the plurality of DBF chips 106, rather than each DBF chip being supported by a dedicated LO. A same subset of antenna elements can be used for transmit and receive signal paths within a chip. As an example, without limitation, each DBF chip of the plurality of DBF chips 106 supports up to 16 antenna elements (M=16) of the plurality of antenna elements 112. In one illustrative example, the global LO 102 is capable of supporting up to 100 DBF chips (L=100) in synchronicity with a global LO signal and common reference clock signal.

Hence, cost savings is achieved by having a reduced number of electrical components within and supporting each DBF chip, space savings is achieved by the fewer number of electrical components, and/or power savings is achieved by not having to fully power transmit and receive components at all times or from the reduced number of electrical components.

It should be understood that DBF chips 106 supporting more or fewer antenna elements can be used without departing from the scope of the present disclosure. In addition, in some cases, the global LO 102 can be capable of supporting more or fewer than 100 DBF chips without departing from the scope of the present disclosure.

However, in some cases, as the number L of DBF chips 106 increases, the power driven by the LO 102 also needs to be increased to handle a corresponding increased load. In some cases, the output of LO 102 can be sufficiently large to produce signal leakage that can create sidelobe interference. In some cases, the radiated signal can violate one or more constraints. For example, the one or more constraints can include potential interference with GEO-belt communication systems, potential interference with other potential satellite communication systems, and regulatory constraints, such as FCC authorization for elevation, or the like.

Communication node 100, also referred to as a node, communication device, device, and/or the like, comprises a part of a communications system. In some embodiments, communication node 100 is included in a wireless communications system, a wideband communications system, a satellite-based communications system, a terrestrial-based communications system, a non-geostationary (NGO) satellite communications system, a low Earth orbit (LEO) satellite communications system, and/or the like. For example, without limitation, communication node 100 can comprise a satellite, a user terminal associated with user device(s), a gateway, a repeater, or other device capable of receiving and transmitting signals with another device of a satellite communications system.

In some cases, LO 102 can be an integrated circuit (IC) chip. In some examples, LO 102 can be included in an IC chip with one or more additional components. Local oscillator (LO) 102, in conjunction with the reference clock 116, is configured to provide a global LO signal to each DBF chip of the plurality of DBF chips 106. The global LO signal is provided to mixers included in the plurality of DBF chips 106 to facilitate performance of synchronized frequency up-conversion to radio frequency (RF) signals to be transmitted and/or down-conversion to received RF signals, as will be described in detail below. LO 102 includes, without limitation, a transmit phase-locked loop (Tx PLL) 118, a receive phase-locked loop (Rx PLL) 120, a multiplexer (MUX) 122, and a power amplifier (PA) 124.

In some cases, the reference clock 116 can provide a clock with a stable frequency. For example, the reference clock 116 can provide a sine wave, square wave, clipped sign wave, or any other suitable reference clock waveform. In some embodiments, reference clock 116 provides a common reference signal to each of the Tx PLL 118 and Rx PLL 120. Tx PLL 118 is configured to generate a signal having a frequency associated with transmission of signals, and the Rx PLL 120 is configured to generate a signal having a frequency associated with receipt of signals. The outputs of the Tx PLL 118 and Rx PLL 120 comprise the inputs to MUX 122.

MUX 122 is configured to select the signal outputted by Tx PLL 118 or Rx PLL 120 in accordance with the transmit or receive mode, respectively, of communication node 100. In each given time, the plurality of DBF chips 106 included in communication node 100 all operate in transmit mode or receive mode.

The output of MUX 122 comprises the input to PA 124. PA 124 is configured to power amplify the signal from the MUX 122. The output of PA 124 comprises the global LO signal generated by a single LO 102 provided to the plurality of DBF chips 106. The global LO signal specifies a precise unmodulated frequency associated with each transmission or receipt of signals by the plurality of DBF chips 106. As an example, the global LO signal may specify a frequency of 5 GigaHertz (GHz) or a frequency that is an integer divided ratio of the RF transmit or RF receive carrier frequency.

The global LO signal generated by the LO 102 is an input to the hierarchical network 104. In some implementations, also provided from LO 102 to the hierarchical network 104 is a reference clock signal such as, for example, a 60 MegaHertz (MHz) signal, to be used by respective clock PLLs included in DBF chips 106 as a digital reference clock signal. The global LO signal may include the reference clock information, or the global LO signal and the reference clock signal can comprise separate signals. The global LO signal and reference clock signal are collectively referred to as a global input signal, a global signal, a driving signal, and/or the like for each DBF chip of the plurality of DBF chips 106.

The hierarchical network 104 is configured to route the global input signal to each DBF chip of the plurality of DBF chips 106. The signal pathway length from the input point of the hierarchical network 104 to each output point of the hierarchical network 104 electrically coupled with a respective DBF chip of the plurality of DBF chips 106 is equal to each other. In other words, all of the signal pathway lengths are length matched to each other. The length matching ensures that there is no propagation delay difference, and thus, introduction of phase differences, in the global input signal delivered to the respective DBF chips 106. The accuracy of global input signal phase among the DBF chips 106 facilitates synchronizing operations of all of the DBF chips 106 to the same timing.

In some embodiments, the global LO signal is distributed to each DBF chip of the plurality of DBF chips 106 with the same phase (or same phase range) to each other. Alternatively, the global LO signal distribution to the plurality of DBF chips 106 can have different phases relative to each other. The different phases can be synchronized or otherwise addressed using calibration or compensation techniques.

In some embodiments, hierarchical network 104 is implemented in one or more layers of a printed circuit board (PCB) stack. LO 102 and the plurality of DBF chips 106 may also be implemented in one or more layers of the PCB stack, which may be the same or different layer(s) from that of the hierarchical network 104. Hierarchical network 104 comprises an H-network (also referred to as an H-tree network), a fractal network, a self-similar fractal network, a tree network, a star network, a hybrid network, a rectilinear network, a curvilinear network, a rectilinear H-network, a curvilinear H-network, a multiplex feed network, or other networks in which each signal inputted to a network traverses through the same length of traces to outputs to avoid spurious signal delays caused by different trace lengths.

The plurality of DBF chips 106 comprises an L number of DBF chips. For example, DBF chip 107 comprises the first DBF chip (i=1, where i=1 to L), and so forth, to DBF chip 108 comprising the Lth DBF chip (i=L) of the plurality of DBF chips 106. Each DBF chip of the plurality of DBF chips 106 electrically couples with a respective M number of antenna elements of the plurality of antenna elements 112. Continuing the example, DBF chip 107 electrically couples with M antenna elements 113 and DBF chip 108 electrically couples with M antenna elements 114. The plurality of DBF chips 106 is electrically coupled to each other in a daisy chain arrangement. The ith DBF chip of the plurality of DBF chips 106 is electrically coupled with the (i+1)th DBF chip. For example, the first DBF chip (i=1) is electrically coupled between modem 110 and the second DBF chip (i=2). The second DBF chip (i−2) is electrically coupled between the first DBF chip (i=1) and the third DBF chip (i=3). The third DBF chip (i=3) is electrically coupled between the second DBF chip (i=2) and the fourth DBF chip (i=4), and so forth, with the last DBF chip (i=L) electrically coupled to the second to last DBF chip (i=L−1).

Each DBF chip of the plurality of DBF chips 106 comprises an IC chip or IC chip package including a plurality of pins, in which at least a first subset of the plurality of pins is configured to communicate signals with its electrically coupled DBF chip(s) (and/or modem 110 in the case of DBF chip 107), a second subset of the plurality of pins is configured to transmit/receive signals with M antenna elements, and a third subset of the plurality of pins is configured to receive the global LO signal (and reference clock signal) from the hierarchical network 104. The plurality of DBF chips 106 may also be referred to as transmit/receive (Tx/Rx) DBF chips, Tx/Rx chips, transceivers, DBF transceivers, and/or the like.

FIG. 1B illustrates an example shared LO configuration for a communication node 150. In the example of FIG. 1B, LO signals can be generated by PLLs included in individual DBF chips 136. In the FIG. 1B, the hierarchical network 134 distributes a reference clock from the reference clock generator 146 to each of the DBF chips 136. The reference clock from the reference clock generator 146 can include a sine wave, square wave, clipped sine wave, or any other suitable waveform. In some cases, a particular DBF chip (e.g., DBF chip 137, 138) of the DBF chips 136 can selectively utilize a shared LO signal generated in its own PLL or a shared LO signal generated by the PLL of a different DBF chip (e.g., DBF chip 138, 137) of the DBF chips 136. In some implementations, small groupings of DBF chips (e.g. two DBF chips, three DBF chips, four DBF chips, or any other suitable number of DBF chips) can be grouped together for mutually sharing of shared LO signals operating at different LO signal frequencies. In some cases, when a PLL of a DBF chip 136 supplies a shared LO signal for a small number of DBF chips, the total power output of any individual PLL can be small, and the likelihood of violating constraints as a result of leakage of the shared LO signal generation can be reduced relative to the global LO signal provided by the LO 102 of FIG. 1A.

In the example of FIG. 1B, the plurality of DBF chips 136 comprises K number of DBF chips. For example, DBF chip 137 comprises the first DBF chip (j=1, where j=1 to K), and so forth, to DBF chip 138 comprising the Kth DBF chip (j-K) of the plurality of DBF chips 136. Each DBF chip of the plurality of DBF chips 136 electrically couples with a respective M number of antenna elements of the plurality of antenna elements 112. Continuing the example, DBF chip 137 electrically couples with M antenna elements 113 and DBF chip 138 electrically couples with M antenna elements 114. The plurality of DBF chips 136 is electrically coupled to each other in a daisy chain arrangement. The jth DBF chip of the plurality of DBF chips 136 is electrically coupled with the (j+1)th DBF chip. For example, the first DBF chip (j=1) is electrically coupled between modem 110 and the second DBF chip (j=2). The second DBF chip (j=2) is electrically coupled between the first DBF chip (j=1) and the third DBF chip (j=3). The third DBF chip (j=3) is electrically coupled between the second DBF chip (j=2) and the fourth DBF chip (j=4), and so forth, with the last DBF chip (j=K) electrically coupled to the second to last DBF chip (j=K−1).

In some embodiments, each DBF chip of the plurality of DBF chips 136 is configured to operate in half duplex mode-capable of receiving or transmitting RF signals/waveforms but not both simultaneously.

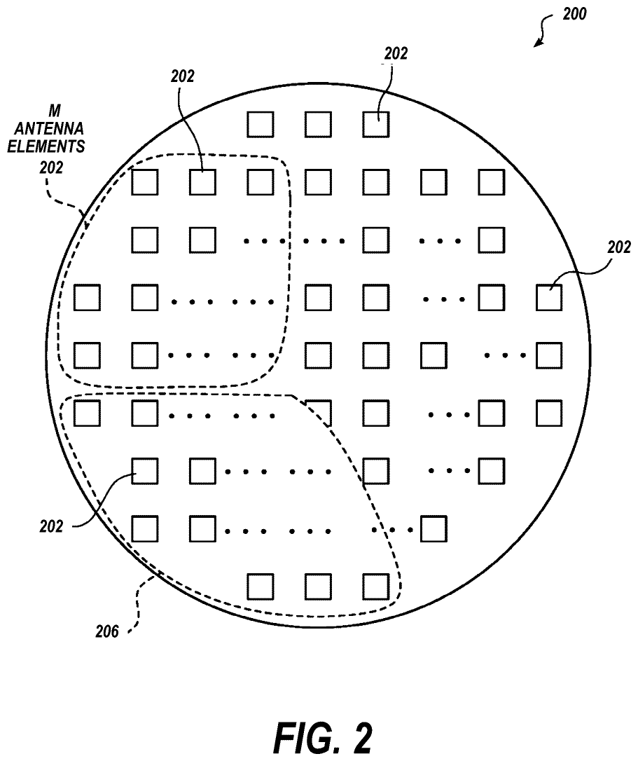

FIG. 2 is an example illustration of a top view of an antenna lattice 200 in accordance with some embodiments of the present disclosure. Antenna lattice 200 includes a plurality of antenna elements 202 arranged in a particular pattern to define a particular antenna aperture. The antenna aperture is the area through which power is radiated by or to the antenna elements 202. Antenna lattice 200 defines a phased array antenna. A phased array antenna synthesizes a specified electric field (phase and amplitude) across an aperture.

In some embodiments, the plurality of antenna elements 202 comprises the plurality of antenna elements 112 in FIG. 1A. A subset 206 of the plurality of antenna elements 202 can comprise the M antenna elements 113 and a subset 206 of the plurality of antenna elements 202 can comprise the M antenna elements 114. The remaining subsets of antenna elements of the plurality of antenna elements 202 may be similarly associated with the remaining DBF chips of the plurality of DBF chips 136.

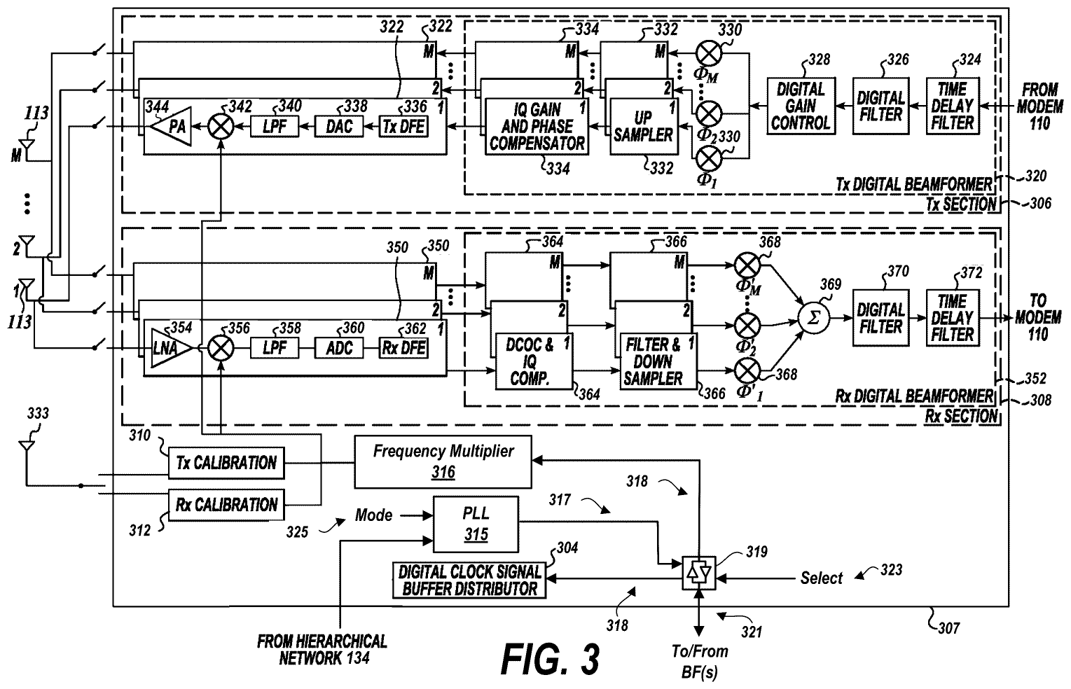

FIG. 3 is an example illustration showing circuitry or electrical components included in and/or associated with the DBF chip 307 in accordance with some embodiments of the present disclosure. In some implementations, the contents of each of the DBF chips 136 of FIG. 1B can be similar to that discussed herein for DBF chip 307.

In some embodiments, DBF chip 307 includes a frequency multiplier 316, a LO signal distributor 304, a transmit section 306, a receive section 308, a transmit calibration section 310, a receive calibration section 312, and a PLL 315. DBF chip 307 is configured to generate RF signals (based on data provided by modem 110) to be transmitted by antenna elements 113, decode RF signals received by antenna elements 113 to provide to modem 110, calibrate the receive section 308 (also referred to as a receiver or receiver section) using the transmit calibration section 310 and calibration antenna element 333, and calibrate the transmit section 306 (also referred to as a transmitter or transmitter section) using the receive calibration section 312 and calibration antenna element 333.

In some cases, the reference clock signal received from the hierarchical network 134 can be input into the PLL 315. In some implementations, the LO signal selection circuitry 319 allows LO signals generated in one or more neighboring DBF chips to be shared. For example, DBF chip 307 and a neighboring DBF may use the LO signal 317 in a first configuration. In some examples, an additional LO signal generated by a PLL of the neighboring DBF chip may have a different frequency from the LO signal 317. In the second configuration, the DBF chip 307 and the neighboring DBF may use the additional LO signal. The output of PLL 315 can be a LO signal 317 electrically coupled to LO signal selection circuitry 319. The LO signal selection circuitry 319 can also be coupled to a LO signal input/output (IO) port 321. In some cases, the LO signal selection circuitry 319 can be configured to provide the LO signal 317 generated by PLL 315 to the LO signal distributor 304 and/or the frequency multiplier 316 in a first configuration. In some cases, in a second configuration, the LO signal selection circuitry 319 can be configured to provide an additional LO signal received at the LO signal IO port 321 to the reference signal distributor 304 and/or frequency multiplier 316. In some examples, a select signal 323 can be used to select between the LO signal 317 generated by the PLL 315 and the additional LO signal received at the LO signal IO port 321. As illustrated, the LO signal selection circuitry 319 can distribute the selected LO signal 318 to one or more additional components of the DBF chip 307. In the illustrated example, a select signal 323 can be configured to determine whether the LO signal 317 or the additional LO signal from the LO signal IO port 321 is the selected signal 318.

In some cases, a frequency of the LO signal provided by the PLL 315 can be selected based on LO mode signal 325. In some aspects, the LO mode signal 325 can be utilized to select a particular frequency for the LO signal generated by the PLL 315. For example, the LO mode signal 325 may be used to select between a first frequency associated with transmitting (Tx) RF signals and a second frequency associated with receiving (Rx) RF signals by the antenna elements 113. In some implementations, PLL 315 may be capable of generating multiple frequencies associated with transmitting (Tx) and/or receiving (Rx) RF signals. In some cases, the PLL 315 can be capable of providing an equal number of frequencies associated with transmitting (Tx) RF signals and receiving (Rx) RF signals. In some cases, the PLL 315 can be capable of providing a different number of frequencies associated with transmitting (Tx) RF signals than a number of frequencies associated with receiving (Rx) RF signals. In some cases, the LO mode signal 325 can be utilized to select between three or more frequencies of the LO signal that can be generated by the PLL 315. In some cases, the LO mode signal 325 can also be used to disable the PLL 315. In some cases, a separate enable signal (not shown) may be provided for enabling and disabling the PLL 315.

In some cases, the selected LO signal 318 is provided to transmit and receive calibration sections 310, 312 to calibrate respective receive and transmit sections 308, 306. Transmit and receive calibration sections 310, 312 are also referred to as transmit and receive calibration sections, calibration Tx and Rx, and/or the like. Transmit and receive calibration sections 310, 312 are selectively electrically coupled to a calibration antenna element 333. A switch is disposed between the calibration antenna element 333 and each of transmit and receive calibration sections 310, 312. If transmit section 306 is to be calibrated, then the switch is configured to electrically couple calibration antenna element 333 to receive calibration section 312 (e.g., switch in a first position). If receive section 308 is to be calibrated, then the switch is configured to electrically couple calibration antenna element 333 to transmit calibration section 310 (e.g., switch in a second position). If neither of sections 306, 308 is to be calibrated, then the switch can be configured in which there is no electrical coupling with neither transmit nor receive calibration sections 310, 312 (e.g., switch in a third position). Although a single switch is depicted in FIG. 3 between calibration antenna element 333 and transmit and receive calibration sections 310, 312, it is contemplated that more than one switch can be implemented, a dedicated switch for each of transmit and receive calibration sections 310, 312.

Calibration antenna element 333 comprises an antenna element (e.g., antenna elements 202 of FIG. 2) included in an antenna lattice (e.g., antenna lattice 200 of FIG. 2). In some embodiments, calibration antenna element 333 is configured for performing calibrations and may not be used for normal or regular signal communication links. Transmit and receive calibration sections 310, 312 are configured to facilitate obtaining calibration measurements so as to adapt transmit and receive sections 306, 308, respectively, to compensate for phase and/or time delay mismatch produced by DBF chip 307, PCB traces, associated antenna elements, and/or associated antenna element circuitry.

In some embodiments, calibration antenna element 333 may comprise any of the M antenna elements 113. In such a configuration, a calibration antenna element 333 dedicated to calibration may be optional.

In some embodiments, the transmit section 306 includes a transmit (Tx) DBF section 320 and a plurality of transmit RF sections 322. The transmit digital beamformer section 320 includes a time delay filter 324, a digital filter 326, a digital gain control 328, a plurality of phase shifters 330, a plurality of up samplers 332, and a plurality of IQ gain and phase compensators 334. Transmit digital beamformer section 320 is also referred to as a baseband section, baseband processing section, and/or the like. A single channel including a data signal or stream is provided by the modem 110 and comprises the input to the time delay filter 324.

The time delay filter 324 is configured to encode or apply a particular time delay u to the received data signal. In an embodiment, time delay filter 324 comprises a finite impulse response filter (FIR), a transversal filter, a Farrow FIR, and/or the like. The time delay encoded data signal is the input to the digital filter 326. Digital filter 326 is configured to de-noise or filter out undesirable signal components from the time delay encoded data signal. Digital filter 326 may be optional where filtering is not necessary due to the quality of the signals provided by the modem 110.

The output of the digital filter 326 is the input to the digital gain control 328. Digital gain control 328 is configured to amplify or apply gain to the filtered signal. The output of the digital gain control 328 is the input to the plurality of phase shifters 330. The phase shifters 330 may also be referred to as phase filters, phase rotators, and/or the like. Each phase shifter of the plurality of phase shifters 330 is configured to encode or apply a particular respective phase to the filtered signal so that the M output signals of the plurality of phase shifters 330 (also referred to as the phase encoded signals) have a different phase relative to each other. For example, without limitation, a first phase shifter (i=1) is configured with phase Φ₁, a second phase shifter (i=2) is configured with phase Φ₂, and so forth, to the Mth phase filter (i=M) is configured for phase Φ_{M}. Each of the M phase encoded signals comprises a signal encoded with a particular time delay and phase that is different from the other phase encoded signals.

Each of the phase encoded signal is the input to a respective up sampler of the plurality of up samplers 332. The phase encoded signal associated with the first phase shifter is the input to the first up sampler (i=1) of the plurality of up samplers 332, the phase encoded signal associated with the second phase shifter is the input to the second up sampler (i=2) of the plurality of up samplers 332, and so forth. In the transmit section 306, there are M signal pathways or paths, including electrical components, to generate M signals to provide to the respective M antenna elements 113 for transmission. The M phase encoded signals are up sampled by the M number of up samplers 332. Each of the up samplers 332 is configured to resample its respective phase encoded signal to a higher sample rate or density. The M up sampled signals are the inputs to respective IQ gain and phase compensators 334.

The plurality of IQ gain and phase compensators 334 comprises M number of IQ gain and phase compensators 334. IQ gain and phase compensators 334 are configured to compensate for any undesirable offset in the transmit path (e.g., perform phase impairment) that may have occurred during signal processing in RF sections 322.

The M outputs of the IQ gain and phase compensators 334 also comprise the outputs of transmit digital beamformer section 320. The M outputs of the IQ gain and phase compensators 334 are the inputs to the respective transmit RF sections 322. Transmit RF sections 322, also referred to as RF sections, are configured to ready the time delay and phase encoded digital signals for transmission. The plurality of the transmit RF sections 322 comprises M number of transmit RF sections 322, one for each of the M paths. Each transmit RF section 322 includes a transmit digital front end (Tx DFE) 336, a digital-to-analog converter (DAC) 338, a low pass filter (LPF) 340, a mixer 342, and a power amplifier (PA) 344.

In each transmit RF section 322, the Tx DFE 336 receives the output of the respective IQ gain and phase compensator 334, a digital signal. Tx DFE 336 is configured to bridge between the digital baseband processing in the transmit digital beamformer section 320 and the analog RF processing to be performed in the transmit RF section 322. Tx DFE 336 may be responsible for one or more processing functions relating to channelization and/or sample rate conversion. Tx DFE 336 is configured to, among other things, resample the input digital signal to a higher sample rate or density and provide the up sampled signal to the DAC 338. For example, the input digital signal may be up sampled by a factor of four. DAC 338 is configured to convert the input digital signal into an analog signal. DAC 338 may comprise an IQ DAC. The time delay and phase encoded digital signal is now a time delay and phase encoded analog signal. The analog signal is the input to LPF 340.

LPF 340 is configured to low pass filter or de-noise the analog signal. The filtered analog signal is the input to mixer 342. Mixer 342 is configured to perform frequency up-conversion to convert the (baseband) center frequency associated with the filtered analog signal to a carrier frequency (e.g., change from f_{DC} to f_{RF}). At least a portion of the input signal from the frequency multiplier 316 is also an input to the mixer 342 in order to perform the frequency up-conversion. The mixers 342 of the M transmit RF sections 322 perform synchronized frequency up-conversion. The time delayed and phase encoded analog signal provided on a carrier frequency, also referred to as a RF signal, is power amplified by the PA 344.

The amplified RF signal outputted by the PA 344 is the input to an antenna element 113. In turn, the antenna element 113 radiates the amplified RF signal. Each of the M antenna elements 113 is configured to radiate an amplified RF signal generated by a respective transmit RF section 322. In some embodiments, impedance matching is implemented between each M path between the transmit RF sections 322 and the antenna elements 113. In readiness of data to be transmitted, electrical couplings are established between the M antenna elements 113 and the transmit section 306 via switches disposed therebetween, thereby completing the signal paths to the M antenna elements 113 from the M transmit RF sections 322 for transmission.

In an embodiment, transmit RF sections 322 may comprise quadrature direct conversion transmitter (IQ) sections, quadrature direct conversion transmitters, or the like. In each of the transmit RF sections 322, a single PA 344 electrically coupled to two sets of Tx DFE 336, DAC 338, LPF 340, and mixer 342 in parallel may be implemented, in which the first set is configured to process the in-phase (I) portion of the I and Q complex signal and the second set is configured to process the quadrature (Q) portion of the I and Q complex signal. The I and Q complex signals are the digital signal outputted by the IQ gain and phase compensator 334 to the transmit RF section 322.

In some embodiments, the receive section 308 includes a plurality of receive RF sections 350 and a receive (Rx) DBF section 352. When DBF chip 307 is operating in receive mode (as opposed to transmit mode discussed above), the plurality of switches disposed between the M antenna elements 113 and the M receive RF sections 350 are configured to establish respective electrical signal paths therebetween. Each of a M number of RF signals detected by the M antenna elements 113 is an input to a respective receive RF section of the plurality of receive RF sections 350, thereby providing M inputs to the M signal pathways or paths of the receive section 308.

In some embodiments, the same M antenna elements 113 are supported by both the transmit and receive sections 306, 308. One or more switches may be included between the antenna elements 113 and the transmit and receive sections 306, 308 to selectively electrically couple the M antenna elements 113 to the transmit or receive section 306, 308. Alternatively, components other than switches may be implemented to establish signal pathways between the antenna elements 113 and the desired transmit or receive section 306, 308. In other embodiments, different sets of M antenna elements may be supported by each of the transmit and receive sections 306, 308. A first set of M antenna elements may be supported by the transmit section 306 and a second/different set of M antenna elements may be supported by the receive section 308.

The plurality of receive RF sections 350 comprises M number of receive RF sections. Each receive RF section 350 includes a low noise amplifier (LNA) 354, a mixer 356, a low pass filter (LPF) 358, an analog-to-digital converter (ADC) 360, and a receive digital front end (Rx DFE) 362. In each receive RF section 350, LNA 354 is configured to perform low noise amplification of the analog RF signal received at the respective antenna element 113. The amplified RF signal is the input to the mixer 356. At least a portion of the input signal generated by the LO 102 also comprises an input to the mixer 356. Mixer 356, also referred to as a down converter, is configured to perform frequency down-conversion to change the center frequency associated with the amplified signal from the RF carrier frequency to the baseband frequency (e.g., change from f_{RF} to f_{DC}). Next, the signal is low pass filtered or de-noised by LPF 358. The filtered signal, which is an analog signal, is converted to a digital signal in ADC 360. ADC 360 may comprise an IQ ADC. The output of ADC 360 is the input to Rx DFE 362.

In each of the receive RF sections 350, a single LNA 354 electrically coupled to two sets of RX mixer 356, LPF 358, ADC 360, and a Rx DFE 362 in parallel may be implemented, in which the first set is configured to process the I portion of the I and Q complex signal and the second set is configured to process the Q portion of the I and Q complex signal.

Rx DFE 362 is configured to bridge between the RF processing in the receive RF section 350 and the digital baseband processing to be performed in the receive digital beamformer section 352. Rx DFE 362 may be responsible for one or more processing functions relating to channelization and/or sample rate conversion. Rx DFE 362 is configured to, among other things, resample the input digital signal to a lower sample rate or density and provide the down sampled signal to the receive digital beamformer section 352.

In some embodiments, the receive digital beamformer section 352 includes a plurality of direct current offset compensator (DCOC) and IQ compensators 364, a plurality of filter and down samplers 366, a plurality of phase shifters 368, an adder 369, a digital filter 370, and a time delay filter 372. The plurality of DCOC and IQ compensators 364 are electrically coupled between the Rx DFEs 362 and the plurality of filter and down samplers 366. The plurality of filter and down samplers 366 is electrically coupled between the plurality of DCOC and IQ compensators 364 and the plurality of phase shifters 368. The plurality of phase shifters 368 is electrically coupled between the plurality of filter and down samplers 366 and the adder 369. The adder 369 is electrically coupled between the plurality of phase shifters 368 and the digital filter 370. The digital filter 370 is electrically coupled between the plurality of phase shifters 368 and the time delay filter 372. Receive digital beamformer section 352 is also referred to as a baseband section, baseband processing section, and/or the like.

The M number of digital signals outputted by the respective receive RF sections 350 comprise the inputs to respective DCOC and IQ compensators 364. The plurality of DCOC and IQ compensators 364 comprises an M number of DCOC and IQ compensators. Each of the DCOC and IQ compensator 364 is configured compensate for any undesirable offsets in the digital signal that may have occurred during signal processing in the receive RF section 350 (e.g., perform phase impairment, DC compensation, etc.), correct for propagation delays, and/or perform other compensations in preparation of phase and time delay decoding. In some embodiments, the digital signal provided to each of the DCOC and IQ compensator 364 includes I and Q components of an IQ complex signal and each of the I and Q components may be separately processed. The compensated digital signals outputted from the DCOC and IQ compensators 364 comprise the inputs to respective filter and down samplers 366.

The plurality of filter and down samplers 366 comprises M number of filter and down samplers, one for each of the M paths of the receive section 308. Each of the filter and down samplers 366 is configured to remove noise and other undesirable components from its compensated digital signal and down sample the signal to a lower sample rate or density. The output of each of the filter and down samplers 366 is the input to a respective phase shifter 368.

The plurality of phase shifters 368 comprises M number of phase shifters. Phase shifters 368 may also be referred to as phase filters, phase rotators, and/or the like. Each phase shifter of the plurality of phase shifters 368 is configured to decode or apply a particular phase to the filtered signal received from a respective filter and down sampler 366. The particular phase applied is selected to undo or cancel the phase applied to the signal for transmission so as to recover the original or underlying data or signal. For example, without limitation, a first phase shifter (x=1 for x=1 to M) is configured with phase Φ′₁ that will decode phase Φ₁, a second phase shifter (x=2) is configured with Φ′₂ that will decode phase Φ₂, and so forth, to the Mth phase shifter (x=M) configured with Φ′_{M} that will decode phase Φ_{M}.

The outputs of the plurality of phase shifters 368 comprise portions of an original or underlying signal without phase encoding but with time delay encoding still to be removed. Such phase decoded signals from the plurality of phase shifters 368 are added or combined together into a single phase decoded signal by the adder 369. Adder 369 may also be referred to as a summation component or combiner. The single phase decoded signal is the input to the digital filter 370. Digital filter 370 is configured to remove undesirable signal components or de-noise the signal phase decoded signal. The filtered signal is then provided to the time delay filter 372.

Time delay filter 372 is configured to decode the time delay present in the filtered signal, which was applied to transmit the signal. A time delay τᵣ applied to the filtered signal may equal in magnitude to time delay τₜ present in the filtered signal, thereby removing the time delay present in the signal and complete reconstitution of the original or underlying signal. The original or underlying signal comprises a channel including a data signal or stream, which is provided to modem 110. If, for example, a particular data signal included in a channel is provided by modem 110 to the transmit section 306, which is transmitted and then received back by the receive section 308, then the signal provided to the modem 110 from time delay filter 372 comprises the particular data signal included in a channel as originally/initially provided by modem 110.

In some embodiments, the receive section 308 may further include one or more electrical components. For example, digital gain control may be provided between the adder 369 and the time delay filter 372 in order to appropriately amplify or provide signal gain to the phase decoded signal.

In this manner, DBF chip 307 is configured to both digitally process a first data signal, stream, or beam of a single channel for transmission by a first plurality of antenna elements; to receive a second data signal, stream, or beam of a single channel using a second plurality of antenna elements; and to digitally recover/reconstitute the original data signal underlying the received signal. The first and second plurality of antenna elements may be the same or different from each other. DBF chip 307 comprises a half-duplex device, configured to operate in transmit mode or receive mode at any given time.

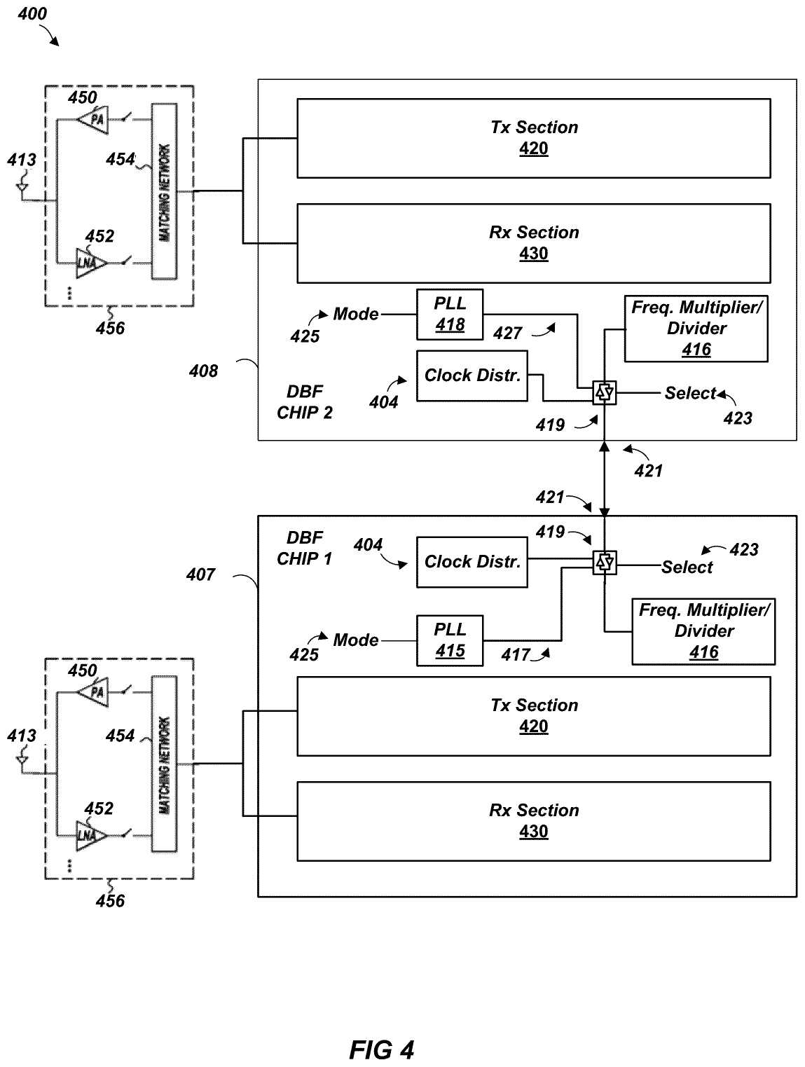

FIG. 4 is an example illustration showing circuitry or electrical components included in and/or associated with a pair of DBF chips 407 and 408 with a shared local oscillator configuration in accordance with some embodiments of the present disclosure. In an embodiment, DBF chips 407 and 408 are similar to DBF chip 307 shown in FIG. 3. In the example of FIG. 4, additional electrical components are included in the signal paths between antenna elements 413 and transmit sections 420 and receive sections 430 of each of the DBF chips 407, 408. Antenna elements 413, transmit sections 420, and receive sections 430 of DBF chips 407, 408 are similar to antenna element 113, transmit section 306, and receive section 308 of FIG. 3, respectively. Disposed between antenna element 413 and a transmit section 420 is a PA 450. Disposed between antenna element 413 and a receive section 430 is LNA 452.

Referring to FIG. 3, the functionality of PA 344 can be configured in two electrical components-a pre-PA (PPA) included in DBF chip 307 and a PA located external to DBF chip 307. PA 450 shown in FIG. 4 is an example of PA 344 of FIG. 3 implemented as two electrical components, in which the PA located external to the chip comprises PA 450. Similarly, the functionality of LNA 354 can be configured in two electrical components-a pre-LNA (PLNA) included in DBF chip 307 and a LNA located external to DBF chip 307. LNA 452 shown in FIG. 4 can be an example of LNA 354 of FIG. 3 implemented as two electrical components, in which the LNA located external to the chip comprises LNA 452.

PA 450 and LNA 452 can be packaged together in a single IC chip (such as IC chip 456) or in separate packages/chips. In some embodiments, IC chip 456 can include additional electrical components such as, but not limited to, an impedance matching network 454 disposed between PA 450 and transmit section 420 and also between LNA 452 and receive (Rx) section 430.

The signal path associated with each of the remaining antenna elements and transmit and receive sections can include similar PAs and LNAs external to the DBF chip. If a chip or package such as IC chip 456 is implemented, then the externally located PAs and LNAs associated with such remaining antenna elements may also be included in the IC chip 456. Alternatively, a separate IC chip or package including a PA, LNA, and impedance matching network can be disposed between an antenna element and its associated transmit and receive sections for each of the antenna elements.

Although PA 450 and LNA 452 are shown disposed between antenna element 413 and the switches, PA 450 and LNA 452 can be disposed between the switches and transmit and receive sections 420, 430.

In the illustrated configuration of FIG. 4, the DBF chip 407 includes a PLL 415 that can provide a first LO signal. Similarly, the DBF chip 408 includes a PLL 418 that can provide a second LO signal. The PLLs 415, 418 can correspond to the PLL 315 of FIG. 3. In some cases, the first LO signal 417 output by the PLL 415 can have a first frequency and the second LO signal 427 output by the PLL 418 can have a second frequency, different from the first frequency. For example, the mode signal 425 can be used to select the first frequency for the first LO signal 417 generated by the first PLL 415. Similarly, the mode signal 425 for can be used to select the second frequency for the second LO signal 427 generated by the second PLL 418. The DBF chips 407, 408 can include frequency multipliers 416 that can increase the frequency of the active reference signal corresponding to the current operating configuration of the DBF chips 407, 408.

In some cases, the DBF chips 407, 408 can operate in a half-duplex mode. In some cases, in the half-duplex mode, the DBF chips 407, 408 can be capable of transmitting and receiving signals, but not at the same time. The DBF chips 407, 408 can have a transmitting (Tx) configuration and a receiving (Rx) configuration. In the example of FIG. 4, the first LO signal produced by PLL 415 can be used as a LO signal for both of the DBF chips 407, 408 in a first configuration (e.g., a transmit (Tx) configuration). In a second configuration (e.g., a receive (Rx) configuration), the second LO signal produced by PLL 418 can be used as a LO signal for both of the DBF chips 407, 408.

In the transmit (Tx) configuration, the receive sections 430 of the DBF chips 407, 408 can be inactive, while the transmit sections 420 can generate transmit signals to transmit over the air by the antenna elements 413. In some examples, the LO signal selection circuitry 419 in DBF chip 407 can distribute the first LO signal 417 from the PLL 415 to the frequency multiplier 416, the clock distributor 404, and/or the LO signal IO port 421 of DBF chip 407. The LO signal selection circuitry 419 of the DBF chip 408 can distribute the first LO signal 417 generated by PLL 415 to the clock distributor 404 and/or frequency multiplier 416 of the DBF chip 408. In some cases, a select signal 423 (e.g., select signal 323 of FIG. 3) can be used to determine whether to distribute the LO signal from the PLL of a DBF chip 407, 408 or the LO signal received at the LO signal IO port of a different DBF chip 408, 407 to the clock distributor 404 and/or frequency multiplier 416 of the DBF chip 407, 408.

In the receive (Rx) configuration, the transmit sections 420 can be inactive, while the receive (Rx) sections 430 can receive signals from the antenna elements 413. In some examples, the LO signal selection circuitry 419 in DBF chip 408 can distribute the additional reference signal from the PLL 418 to the frequency multiplier 416, the clock distributor 404, and/or the LO signal IO port 421 of DBF chip 408. The LO signal selection circuitry 419 of the DBF chip 407 can distribute the additional reference signal generated by PLL 418 to the clock distributor 404 and/or frequency multiplier 416 of the DBF chip 407.

The frequency multipliers 416 can be similar to and perform similar functions to the frequency multiplier 316 of FIG. 3. The DBF chips 407, 408 can also include clock distributors 404 for distributing and/or buffering the selected LO signal for digital clock operations within the DBF chips 407, 408. In some embodiments, one or more of the transmit or receive signal paths of DBF chips 407 and/or 408 can be effectively enabled or disabled by dynamic control of multiple enabling signal(s).

In some cases, reference signals generated by PLL 415 or PLL 418 can both remain locked despite both DBF chips 407, 408 performing transmit and/or receive functionality based on a shared reference signal from one PLL (e.g., PLL 415 or PLL 418). In some cases, by maintaining the lock in the PLL generating the unused LO signal, the DBF chips 407, 408 can switch configurations without having to wait for the non-selected PLL to start up (e.g., lock).

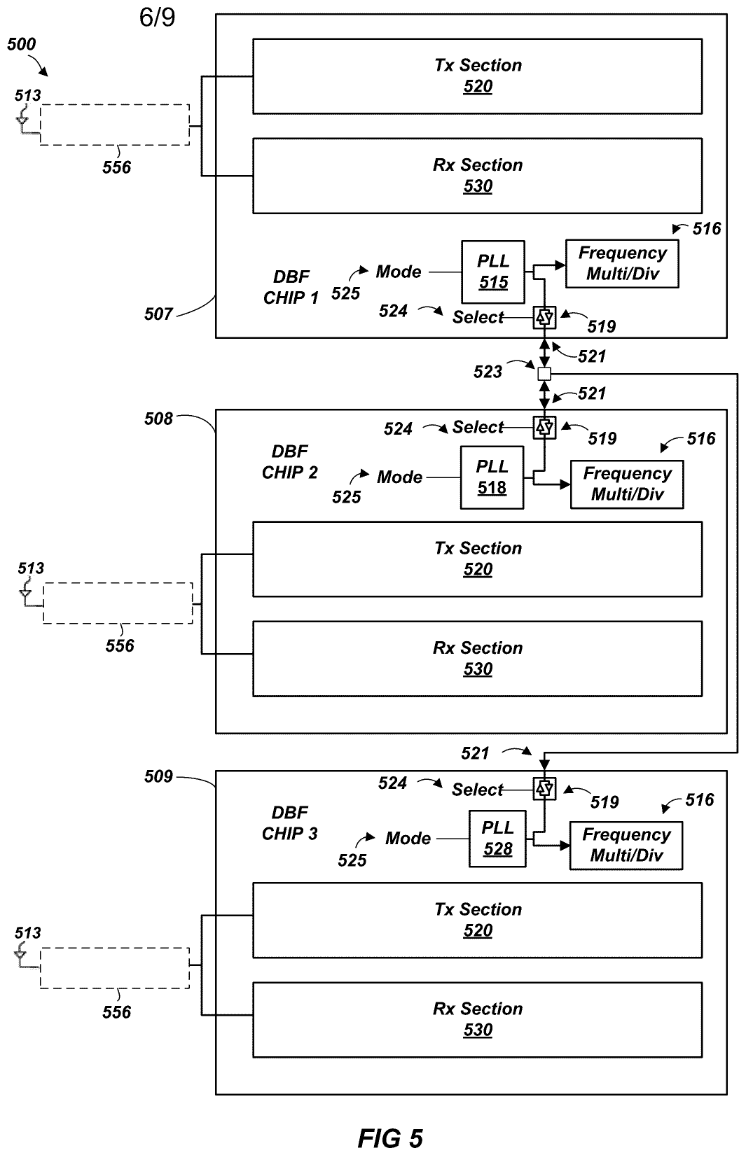

FIG. 5 is an example illustration showing circuitry or electrical components included in and/or associated with a shared LO configuration 500 of three DBF chips 507, 508, and 509 with a shared local oscillator configuration. Each of the DBF chips 507, 508, 509 includes a transmit (Tx) section 520 and a receive (Rx) section 530. As illustrated in FIG. 5, the DBF chips 507, 508, 509 can be coupled to antenna elements 513 by IC chips 556. The IC chips 556 can be similar to and perform similar functions to the IC chips 456 of FIG. 4. Antenna elements 513, transmit sections 520, and receive sections 530 of DBF chips 507, 508, 509 are similar to antenna element 113, transmit section 306, and receive section 308 of FIG. 3, respectively.

In the illustrated configuration of FIG. 5, the DBF chip 507 includes a PLL 515 that can provide a first LO signal. Similarly, the DBF chip 508 includes a PLL 518 that can provide a second LO signal. In the example of FIG. 5, the DBF chip 509 includes a PLL 528, which can provide a third shared LO signal and/or can be disabled. In some cases, the mode signal 525 can be used to select the frequency and/or enable/disable the PLL 528. The PLLs 515, 518, 528 can correspond to the PLL 315 of FIG. 3. In some cases, the first LO signal output by the PLL 515 can have a first frequency and the second LO signal output by the PLL 518 can have a second frequency, different from the first frequency. The DBF chips 507, 508, 509 can include frequency multipliers 516 that can increase the frequency of the active reference signal corresponding to the current operating configuration of the DBF chips 507, 508, 509. The frequency multipliers 516 can be similar to and perform similar functions to the frequency multiplier 316 of FIG. 3. The DBF chips 507, 508, 509 can also include clock distributors (not shown) for distributing and/or buffering the selected reference signal (e.g., selected by LO signal selection circuits 519) for digital clock operations within the DBF chips 507, 508, 509. For example, the DBF chips 507, 508, 509 can include clock distributors that are similar to and perform similar functions to the clock distributors 404 shown in FIG. 4.

In some embodiments, one or more of the transmit or receive signal paths of DBF chips 507, 508, and/or 509 can be effectively enabled or disabled by dynamic control of multiple enabling signal(s).

In some cases, the DBF chips 507, 508, 509 can operate in a half-duplex mode. In some cases, in the half-duplex mode, the DBF chips 507, 508, 509 can be capable of transmitting and receiving signals, but not at the same time. The DBF chips 507, 508, 509 can have a transmitting (Tx) configuration and a receiving (Rx) configuration. In the example of FIG. 5, the first LO signal produced by PLL 515 can be used as a first LO signal for the three DBF chips 507, 508, 509 in a first configuration (e.g., a transmit (Tx) configuration). As illustrated, a frequency for the first LO signal can be selected by the mode signal 525, which can correspond to the mode signal 425 of FIG. 4. In a second configuration (e.g., a receive (Rx) configuration), the second LO signal produced by PLL 518 can be used as a second LO signal for the three DBF chips 507, 508, 509. In some cases, a frequency for the second LO signal can be selected by the mode signal 525.

In some cases, select signal 524 can be used to select between an LO signal from a PLL included in a DBF and an additional LO signal from the LO signal IO port 521 of a different DBF. For example, the select signal 524 of the DBF chip 507 can be used to select between the first LO signal generated by the PLL 515 and the second LO signal generated by the PLL 518 and received at the LO signal IO port 521 of the DBF chip 507. In addition, the select signal 524 of the DBF chip 508 can be used to select between the second LO signal generated by the PLL 518 and the first LO signal generated by the PLL 515 and received at the LO signal IO port 521 of the DBF chip 508. In the illustrated example, the select signal 524 of the DBF chip 509 can be used to select the LO signal received at the LO signal IO port 521, which can change between the first LO signal generated by the PLL 515 or the second LO signal generated by the PLL 518. In some cases, the select signals 524 can be coordinated to prevent simultaneously outputting two different LO signals to the LO signal distribution network 523.

In the transmit (Tx) configuration, the receive sections 530 of the DBF chips 507, 508, 509 can be inactive, while the transmit sections 520 can generate transmit signals to transmit over the air by the antenna elements 513. In some examples, the LO signal selection circuitry 519 in DBF chip 507 can distribute the first LO signal from the PLL 515 to the frequency multiplier 516, the clock distributor (not shown), and/or the reference signal IO port 521 of DBF chip 507. The LO signal selection circuitry 519 of the DBF chip 508 can distribute the first LO signal generated by PLL 515 to the clock distributor (not shown) and/or frequency multiplier 516 of the DBF chip 508. In addition, the LO signal selection circuitry 519 of the DBF chip 509 can distribute the reference signal generated by PLL 515 to the clock distributor (not shown) and/or frequency multiplier 516 of the DBF chip 509. The LO signal distribution network 523 can distribute the first LO signal generated by PLL 515 to the LO signal IO ports 521 of the DBF chips 508, 509.

In the receive (Rx) configuration, the transmit sections 520 of the DBF chips 507, 508, 509 can be inactive, while the receive (Rx) sections 530 can receive signals from the antenna elements 513. In some examples, the LO signal selection circuitry 519 in DBF chip 508 can distribute the second LO signal from the PLL 518 to the frequency multiplier 516, the clock distributor (not shown), and/or the LO signal IO port 521 of DBF chip 508. The LO signal selection circuitry 519 of the DBF chip 507 can distribute the second LO signal generated by PLL 518 to the clock distributor (not shown) and/or frequency multiplier 516 of the DBF chip 507. In addition, the LO signal selection circuitry 519 of the DBF chip 509 can distribute the additional LO signal generated by PLL 518 to the clock distributor (not shown) and/or frequency multiplier 516 of the DBF chip 509. The LO signal distribution network 523 can distribute the second LO signal generated by PLL 518 to the LO signal IO ports 521 of the DBF chips 507, 509.

In some cases, LO signals generated by PLL 515 or PLL 518 can both remain locked despite all three DBF chips 507, 508, 509 performing transmit and/or receive functionality based on a selected LO signal (e.g., by the LO signal selection circuitry 519) from one PLL (e.g., PLL 515 or PLL 518). In some cases, by maintaining the phase lock in the inactive PLL, the DBF chips 507, 508, 509 can switch configurations without having to wait for the non-selected PLL to start up (e.g., lock).

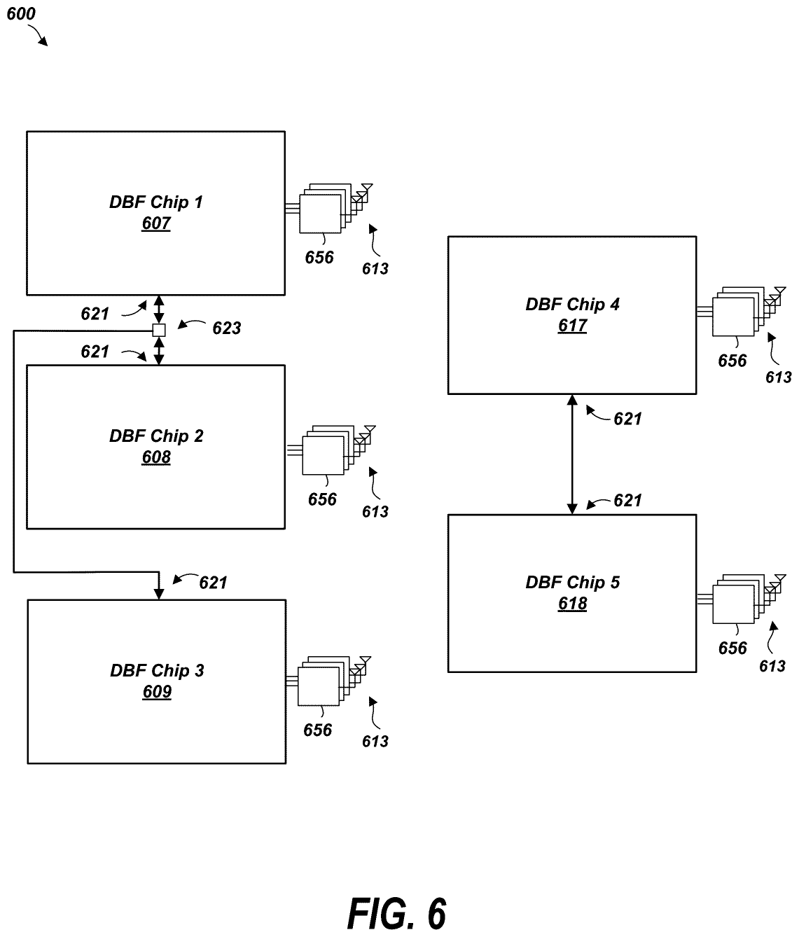

FIG. 6 is an example illustration of a shared LO configuration 600 including five DBF chips 607, 608, 609, 617, 618. In the example of FIG. 6, DBF chips 607, 608, 609 are arranged in a shared LO configuration 600 that can correspond to the shared LO configuration 500 of FIG. 5. In addition, the DBF chips 617, 618 are arranged in a shared LO configuration that can correspond to the shared LO configuration 400 of FIG. 4. As illustrated in FIG. 1B, a reference clock signal can be distributed from a reference clock to PLLs (e.g., PLL 315 of FIG. 3) included in each of the DBF chips 607, 608, 609, 617, 618.

In FIG. 6, IC chips 656 are shown between each of the DBF chips 607, 608, 609, 617, 618 and the antenna elements 613. The IC chips 656 can be similar to and perform similar functionality to the IC chip 456 of FIG. 4. For example, the IC chip 656 can include PAs 450 and/or LNAs 452 of FIG. 4.

In one illustrative example, the PLLs (not shown) included in DBF chips 607 and 617 can be configured to provide a first LO signal for a first BF configuration (e.g., for transmitting signals by antenna elements 613). For example, the PLLs (not shown) in the DBF chips 607, 617 can be configured to provide a LO signal associated with transmitting (Tx) RF signals.

In one illustrative example, the PLLs (not shown) included in DBF chips 608 and 618 can be configured to provide a second LO signal for operations in a second BF configuration (e.g., for receiving signals by antenna elements 613). For example, the PLLs (not shown) in the DBF chips 608, 618 can be configured to provide a second LO signal associated with receiving (Rx) RF signals.

In one illustrative example, the PLL (not shown) included in DBF chip 609 can be disabled based on a mode input (e.g., LO mode signal 325 of FIG. 3). For example, the DBF chip 609 can transmit RF signals based on the first LO signal at LO signal IO port 621 of the DBF chip 609 and receive RF signals based on the second LO signal received at LO signal IO port 621 of the DBF chip 609. In some implementations, the DBF chip 609 may not include a PLL.

As described above with respect to FIG. 4 and FIG. 5, select signal 623 (e.g., select signal 323 of FIG. 3) can be used to select between the LO signal generated within a particular DBF chip 607, 608, 609, 617, 618 and the LO signal received at LO signal IO port 621 of the DBF chip 607, 608, 609, 617, 618.

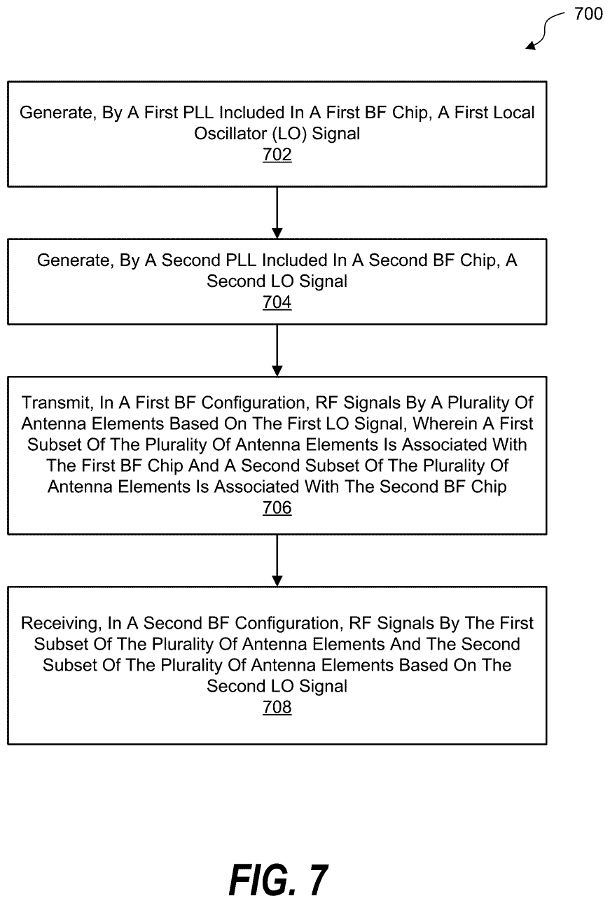

Having disclosed example systems, components and concepts, the disclosure now turns to the example process 700 for sharing LO signals (e.g., from a PLL), as shown in FIG. 7. The steps outlined herein are non-limiting examples provided for illustration purposes, and can be implemented in any combination thereof, including combinations that exclude, add, or modify certain steps.

At block 702, the process 700 includes generating, by a first PLL (e.g., PLL 315 of FIG. 3, PLL 415 of FIG. 4) included in a first BF chip (e.g., DBF chip 307 of FIG. 3, DBF chip 407 of FIG. 4, DBF chip 507 of FIG. 5), a first LO signal (e.g., LO signal 317 of FIG. 3, first LO signal 417 of FIG. 4). In some cases, a first frequency (e.g., a frequency associated with transmitting (Tx) or receiving (Rx) signals) of the first LO signal is configured based on a first mode signal (e.g., LO mode signal 325 of FIG. 3) of the first PLL.

At block 704, the process 700 includes generating, by a second PLL (e.g., PLL 315 of FIG. 3, PLL 418 of FIG. 4) included in a second BF chip (e.g., DBF chip 307 of FIG. 3, DBF chip 408 of FIG. 4, DBF chip 508 of FIG. 5), a second LO signal (e.g., LO signal 317 of FIG. 3, second LO signal 427 of FIG. 4). a second frequency of the second LO signal is configured based on a second mode signal (e.g., LO mode signal 325 of FIG. 3) of the second PLL. In some cases, the first frequency is different from the second frequency.

At block 706, the process 700 includes transmitting, in a first BF configuration, based on the first LO signal, RF signals by a plurality of antenna elements (e.g., m antenna elements 113 of FIG. 3, antenna elements 413 of FIG. 4, antenna elements 513 of FIG. 5). In some cases, a first subset of the plurality of antenna elements transmitting the RF signals is associated with the first BF chip and a second subset of the plurality of antenna elements transmitting the RF signals is associated with the second BF chip.

At block 708, the process 700 includes receiving, in a second BF configuration, based on the second LO signal, RF signals by the first subset of the plurality of antenna elements and the second subset of the plurality of antenna elements.

In some cases, the process 700 includes, in the first BF configuration, transmitting LO signals by a third subset of the plurality of antenna elements associated with a third BF (e.g., DBF chip 509 of FIG. 5) based on the first LO signal. In some examples, the process 700 includes, in the second BF configuration, receiving LO signals by the third subset of the plurality of antenna elements based on the second LO signal. In some cases, a third PLL (e.g., LO mode signal 325 of FIG. 3) of the third BF chip is disabled based on a third mode signal of the third PLL.

In some cases, the first IC chip and the second IC chip are configured to selectively alternate between transmitting RF signals and receiving RF signals based on one or more mode signals. In some cases, the first IC chip and the second IC chip are configured to up-convert signals based on the first LO signal to generate the RF signals for transmitting RF signals in a transmitting (Tx) configuration. In some examples, In some cases, the first IC chip and the second IC chip are configured to down-convert received RF signals based on the second LO signal in a receiving (Rx) configuration.

In some cases, an LO signal distribution component (e.g., LO signal distribution network 523 of FIG. 5) is configured to distribute the first LO signal to the second BF chip and the third BF chip in the first beamforming configuration. In some aspects, the LO signal distribution component is configured to distribute the second LO signal to the first BF chip and the third BF chip in the second beamforming configuration.

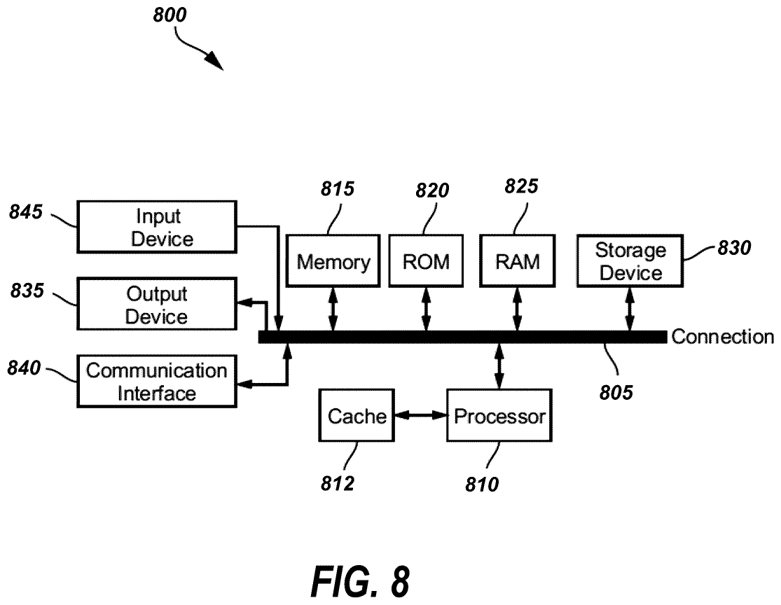

In some examples, the process 700 may be performed by one or more computing devices or apparatuses. In one illustrative example, the process can be performed by a communication node shown in FIG. 1B and/or one or more computing devices with the computing device architecture 800 shown in FIG. 8. In some cases, such a computing device or apparatus may include a processor, microprocessor, microcomputer, or other component of a device that is configured to carry out the steps of the process 700. In some examples, such computing device or apparatus may include one or more antennas for sending and receiving RF signals. In some examples, such computing device or apparatus may include an antenna and a modem for sending, receiving, modulating, and demodulating RF signals, as previously described.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement various techniques described herein. For example, the computing device architecture 800 can be used to perform at least some operations described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general purpose processor and a hardware or software service stored in storage device 830 and configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device. In some instances, multimodal computing devices can enable a user to provide multiple types of input to communicate with the computing device architecture 800. The communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include software, code, firmware, etc., for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

Many embodiments of the technology described herein may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including an organic light emitting diode (OLED) display or liquid crystal display (LCD).

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

1. A phased array antenna system comprising:
a plurality of antenna elements;
a reference clock; and
a beamformer (BF) chip comprising:
a phase-locked loop (PLL) configured to output a local oscillator (LO) signal by a LO signal output based on the reference clock; and
a LO signal input/output (IO) port configured to output the LO signal from the BF chip in a first beamforming configuration and to receive an additional LO signal in a second beamforming configuration.

2. The phased array antenna system of claim 1, further comprising:
one or more LO signal selection components, wherein the one or more LO signal selection components are configured to couple the LO signal IO port to the LO signal output of the PLL in the first beamforming configuration and to disconnect the LO signal IO port from the LO signal output of the PLL in the second beamforming configuration.

3. The phased array antenna system of claim 1, wherein the PLL is configured to select an output frequency of the LO signal based on a mode signal.

4. The phased array antenna system of claim 3, wherein:
the mode signal comprises an enable signal; and
the PLL is configured to selectively enable outputting the LO signal based on the enable signal.

5. The phased array antenna system of claim 1, wherein, in the second beamforming configuration, the PLL is configured to continue generating the LO signal.

6. The phased array antenna system of claim 1, wherein the first beamforming configuration comprises a transmitting (Tx) configuration and the second beamforming configuration comprises a receiving (Rx) configuration.

7. The phased array antenna system of claim 6, wherein a transmit beamformer section of the BF chip is configured to up-convert signals based on the LO signal in the transmitting (Tx) configuration and a receive beamformer section of the BF chip is configured to down-convert signals based on the additional LO signal in the receiving (Rx) configuration.

8. The phased array antenna system of claim 1, wherein the first beamforming configuration comprises a receiving (Rx) configuration and the second beamforming configuration comprises a transmitting (Tx) configuration.

9. The phased array antenna system of claim 1, wherein the BF chip further comprises a frequency multiplier electrically coupled to generate an upscaled LO signal, wherein:
a frequency of the upscaled LO signal is a first multiple of a frequency of the LO signal in the first beamforming configuration; and
the frequency of the upscaled LO signal is a second multiple of a frequency of the additional LO signal in the second beamforming configuration.

10. The phased array antenna system of claim 9, wherein the first multiple of the frequency of the LO signal and the second multiple of the frequency of the additional LO signal are equal.

11. The phased array antenna system of claim 1, further comprising:
an additional BF chip comprising:
an additional PLL configured to output the additional LO signal, by an additional LO signal output based on the reference clock; and
an additional LO signal IO port configured to output the additional LO signal from the additional BF chip in the first beamforming configuration and to receive the LO signal from the BF chip in the second beamforming configuration.

12. The phased array antenna system of claim 11, further comprising:
a third BF chip comprising a third LO signal IO port configured to receive the LO signal from the BF chip in the first beamforming configuration and to receive the additional LO signal from the additional BF chip in the second beamforming configuration.

13. The phased array antenna system of claim 12, further comprising a LO signal distribution component, wherein the LO signal distribution component is configured to distribute the LO signal to the additional BF chip and the third BF chip in the first beamforming configuration and distribute the additional LO signal to the BF chip and the third BF chip in the second beamforming configuration.

14. The phased array antenna system of claim 12, wherein the third BF chip comprises a third PLL coupled to the reference clock, wherein a third LO signal output of the third PLL is coupled to a third LO signal IO port.

15. The phased array antenna system of claim 14, wherein the third PLL is disabled based on a mode signal.

16. The phased array antenna system of claim 12, further comprising:
a fourth BF chip comprising:
a fourth LO signal IO port;
a fourth PLL configured to generate a fourth LO signal based on the reference clock; and
a fourth LO signal IO port configured to output the fourth LO signal in the first beamforming configuration and receive a fifth LO signal in the second beamforming configuration; and
a fifth BF chip comprising:
a fifth LO signal IO port;
a fifth PLL configured to generate a fifth LO signal based on the reference clock; and
a fifth LO signal IO port configured to output the fifth LO signal in the first beamforming configuration and receive the fourth LO signal in the second beamforming configuration.

17. The phased array antenna system of claim 16, wherein:
the LO signal and the fourth LO signal have a first common frequency; and
the additional LO signal and the fifth LO signal have a second common frequency.

18. The phased array antenna system of claim 1, wherein the BF chip receives the reference clock from a reference clock signal distribution network.

19.-25. (canceled)

26. A method for sharing LO signals in a phased array antenna system comprising:
generating, by a first PLL included in a first BF chip, a first LO signal;
generating, by a second PLL included in a second BF chip, a second LO signal;
transmitting, in a first BF configuration, based on the first LO signal, RF signals by a plurality of antenna elements, wherein a first subset of the plurality of antenna elements transmitting the RF signals is associated with the first BF chip and a second subset of the plurality of antenna elements transmitting the RF signals is associated with the second BF chip; and
receiving, in a second BF configuration, based on the second LO signal, RF signals by the first subset of the plurality of antenna elements and the second subset of the plurality of antenna elements.

27. The method of claim 26, wherein the first PLL and the second PLL remain active during the first BF configuration and the second BF configuration.

28. The method of claim 26, wherein:
a first frequency of the first LO signal is configured based on a first mode signal of the first PLL; and
a second frequency of the second LO signal is configured based on a second mode signal of the second PLL.

29. The method of claim 28, wherein the first frequency is different from the second frequency.

30. The method of claim 26, further comprising:
in the first BF configuration, transmitting LO signals by a third subset of the plurality of antenna elements associated with a third BF chip based on the first LO signal; and
in the second BF configuration, receiving LO signals by the third subset of the plurality of antenna elements based on the second LO signal.

31. The method of claim 30, wherein a third PLL of the third BF chip is disabled based on a third mode signal of the third PLL.
